(19) United States
(12) Patent Application Publication
(10) Pub. No.: US 2012/0186149 A1
(43) Pub. Date: Jul. 26, 2012

(54) Garden Support System and Method

(76) Inventor: Donald D. Dray, Rockford, IL (US)

(21) Appl. No.: 12/982,028

(22) Filed: Jan. 26, 2011

(51) Int. Cl. A01G 17/06; A01G 1/00

(52) U.S. Cl. 47/45; 47/58.1 R

(57) ABSTRACT

A garden support system according to one embodiment includes a plurality of support poles having a generally elongated pole body. At least one of the support poles has a first end that includes a tapered portion for insertion into a support medium. The system includes a plurality of alignment members for joining the support poles in a grid arrangement for supporting at least one plant. The alignment members each have a pair of channels each for receiving a corresponding support pole therein. When the alignment members and support poles are joined, the alignment members hold the support poles in place by a friction fit between the respective pole bodies and channels and permit adjustment of the grid arrangement by sliding an alignment member along a corresponding pole body.

### BRIEF DESCRIPTION OF THE DRAWINGS

FIG. 1 is a perspective view of a garden support system supporting an adjacent plant according to one embodiment;

FIG. 2 is a perspective view of a support pole according to one embodiment;

FIG. 3 is an exploded perspective view of a support pole according to one embodiment;

FIG. 4 is a cross-sectional view of a support pole receiving a driving force according to one embodiment;

FIG. 5A is a perspective view of an alignment member according to a first example embodiment;

FIG. 5B is a side elevation view of the alignment member shown in FIG. 5A;

FIG. 5C is a front elevation view of the alignment member shown in FIG. 5A;

FIG. 5D is a top plan view of the alignment member shown in FIG. 5A;

FIG. 6A is a perspective view of an alignment member according to a second example embodiment;

FIG. 6B is a side elevation view of the alignment member shown in FIG. 6A;

FIG. 6C is a front elevation view of the alignment member shown in FIG. 6A;

FIG. 6D is a top plan view of the alignment member shown in FIG. 6A;

FIG. 7 is a perspective view of a garden support system according to a first example embodiment; and

FIG. 8 is a perspective view of a garden support system according to a second example embodiment.

The following description and drawings illustrate multiple embodiments sufficient to enable those skilled in the art to practice the embodiments. It is to be understood that the subject matter of this application is not limited to the details of construction and the arrangement of components set forth in the following description or illustrated in the drawings. The subject matter is capable of other embodiments and of being practiced or of being carried out in various ways. For example, other embodiments may incorporate structural, chronological, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present application is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

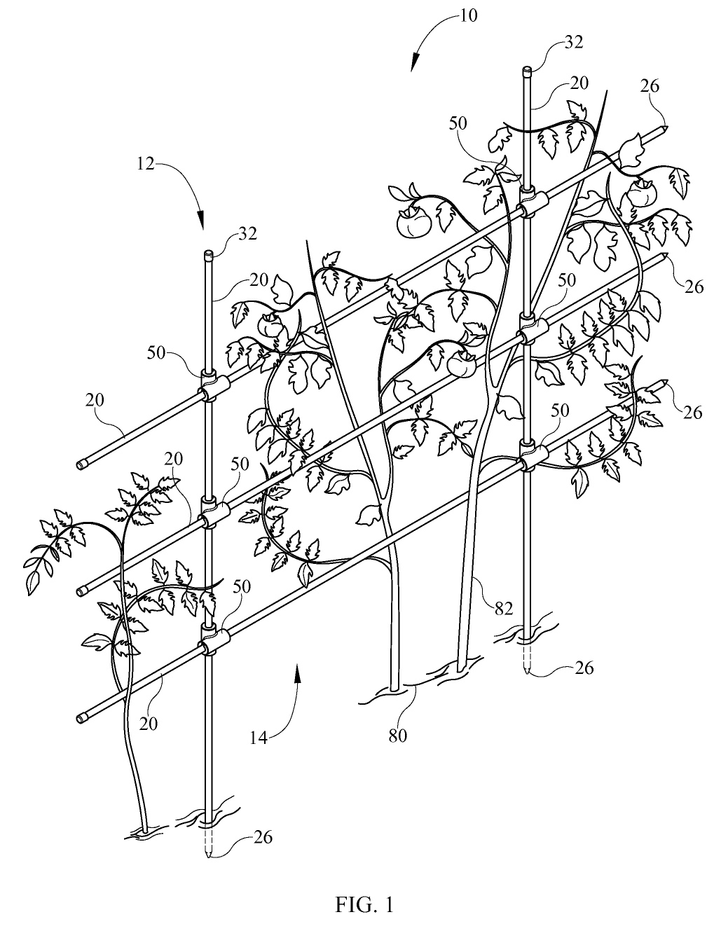

FIG. 1 shows an example embodiment of a garden support system 10. The system includes a plurality of support poles 20 and a plurality of alignment members 50. A garden support structure 12 may be provided by joining the support poles 20 together in a grid arrangement 14 using the alignment members 50. A portion of at least one of the poles 20 is inserted into a support medium 80 such as, for example, the ground in order to support the structure 12 in an upright position. In operation, the structure 12 is inserted adjacent to a plant 82 such that the grid arrangement 14 provides support for the plant 82 as it grows.

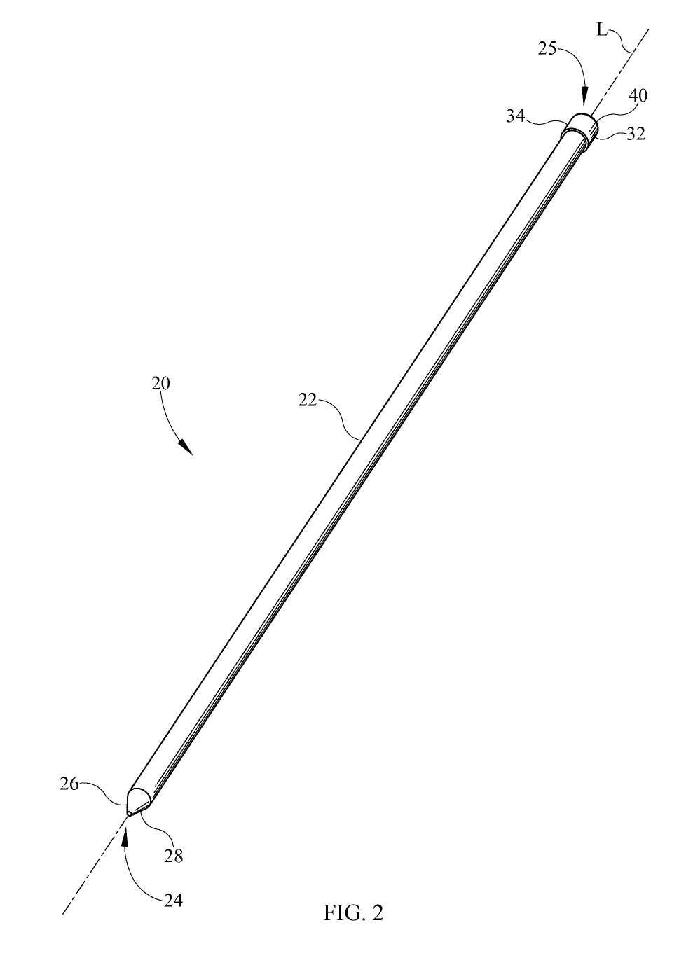

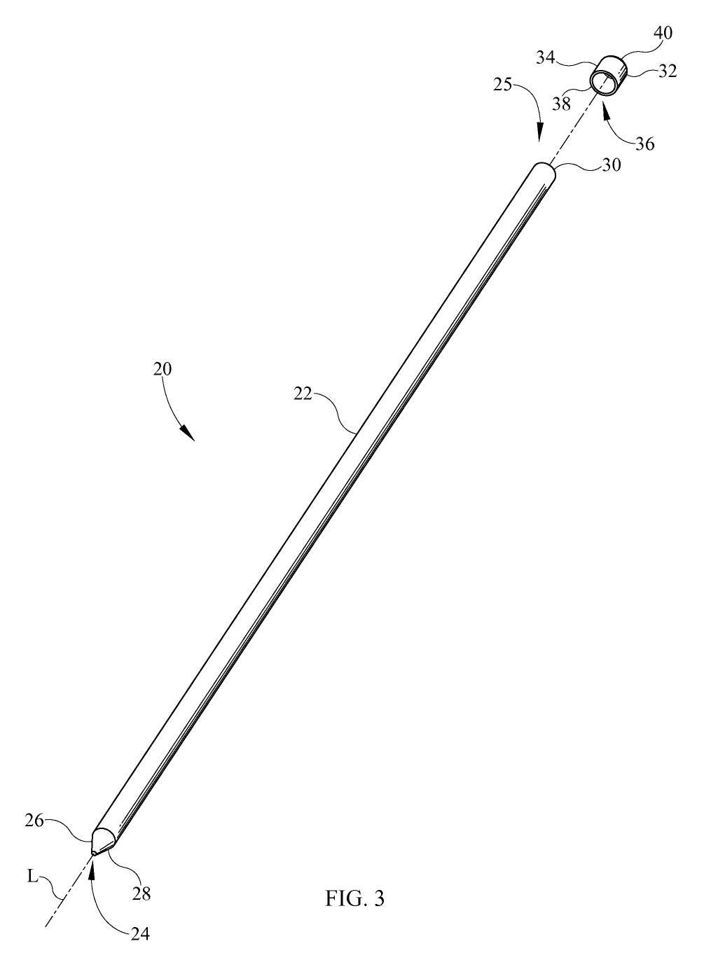

With reference to FIGS. 2 and 3, the support poles 20 include a generally elongated pole body 22. The pole body 22 may be formed from fiberglass, plastic or other lightweight, resilient and weather-resistant material extending along a longitudinal axis L thereof. The material composition of the pole body 22 provides the shock transmission necessary to efficiently allow a user to drive the pole 20 into the ground. The material composition of the pole body 22 also provides durability and facilitates repeated and continued use of the poles 20 year after year.

The pole body 22 includes a first end 24 and a second end 25. The first end 24 is defined by a tapered portion 26 having generally conical walls 28 for insertion into the support medium 80. In some embodiments, the tapered portion 26 ends in a pointed tip. Alternatives include those wherein the tapered portion 26 reduces to a generally flat end surface having a radius less than the radius of the pole body 22. Additional alternatives include those wherein the tapered portion 26 ends in any suitable shape such as, for example, to a rounded tip. The pole body 22 extends along the generally longitudinal axis L thereof. This configuration allows for reversible and removable insertion of the pole 20 into the support medium 80. The tapered portion 26 provides a small pressure surface for ground contact to enhance the ability of a user to force the pole 20 into the support medium 80. The configuration of the tapered portion 26 allows for ease of repeated driving insertion into the support medium 80. In some embodiments, the slope of the tapered portion 26 forms an angle of greater than forty-five degrees from the centerline longitudinal axis L of the pole body 22. The relative bluntness of the pole 20 piles up dirt ahead of the pole 20 more rapidly than a more gradual taper and therefore helps to prevent over-insertion of the pole 20. In some embodiments, the second end 25 of the pole body 22 includes a generally flat upper surface 30. Alternatives include those wherein the upper surface 30 of the second end 25 is formed with a rough surface such as may be left by a saw or machine cut. In one example embodiment, the diameter of the pole body 22 is between about one-quarter inch and about one-half inch. The length of each pole 20 is dictated by the requirements of the structure 12; however, in one example embodiment, the length of each pole 20 is between about 3 feet and about 4 feet. Accordingly, the poles 20 may be driven relatively deep into the ground such as, for example 1 foot to 2 feet into the ground in order to provide maximum support for the structure 12.

In the example embodiment illustrated in FIGS. 2 and 3, the pole 20 includes an impact cap 32 disposed at the second end 25 of the pole body 22. The impact cap 32 includes a cylindrical wall 34. A nail-head surface 40, comprising a generally flat end panel, is formed integrally with the cylindrical wall 34 to ultimately form the impact cap 32. Some embodiments of the nail-head surface 40 have a substantially planar surface. The nail-head surface 40 and cylindrical wall 34 define an internal cavity 36 having an access opening 38 into which the second end 25 of the pole body 22 projects. The impact cap 32 includes a substantially planar surface opposing the access opening 38. Embodiments include those wherein the access opening 38 provides access to the internal cavity 36 of the cylindrical walls 34. As desired, the diameter of the internal cavity 36 is selected to be slightly larger than the diameter of the pole body 22 such that the second end 25 of the pole body 22 fits snugly within the internal cavity 36. In some embodiments, the impact cap 32 is fitted over the second end 25 of the pole body 22 in a snug, friction-fitting manner. In some embodiments, the planar surface of the impact cap 32 opposing the access opening 38 is in substantial contact with the upper surface 30 of the second end 25 of the pole body 22 when the impact cap 32 is fitted over the second end 25 of the pole body 22. The impact cap 32 allows the user to drive the pole 20 into the ground by applying force directly to the impact cap 32. In some embodiments, the impact cap 32 is generally undeformable and generally unbreakable thereby providing durability and facilitating repeated and continued use of the pole 20 year after year.

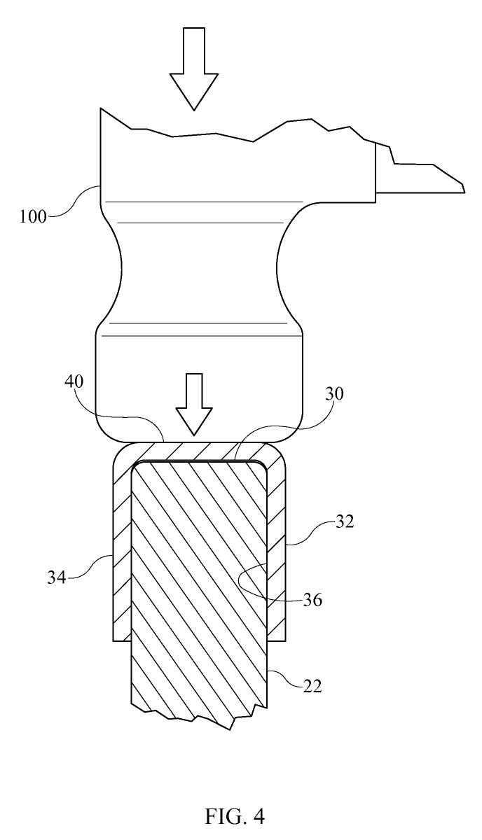

With reference to FIG. 4, providing the nail-head surface 40 in combination with the cylindrical wall portion 34, forms an effective impact structure to receive blows from a driving implement 100 such as, for example, a hammer, and to distribute the resultant forces effectively. As shown, the impact cap 32 has a generally cylindrical profile. The impact force is substantially evenly transmitted to the pole 20. Upon receiving impact force from the driving implement 100, the impact cap 32 distributes the impact force evenly over the pole 20, thereby achieving enhanced efficiency and reduced force transmission sequentially from the driving implement 100, to the flat nail head surface 40 of the impact cap 32, to the planar surface of the impact cap 32, and to the upper surface 30 of the second end 25 of the pole body 22 during reversible and removable insertion of the pole 20 into the support medium 80.

In operation, a user may take a hammer or other driving implement 100 to the impact cap 32 to drive the pole 20 into the support medium 80. In some embodiments, one or two blows are sufficient to drive the pole 20 sufficiently into the ground. The impact cap 32 provides the ability to drive the pole 20 into the support medium 80 to the extent that it will typically not blow over and will be able to support the weight of the plant 82 as it grows. Further, in some embodiments, the impact cap 32 prevents the upper surface 30 of the second end 25 of the pole body 22 from splintering, mushrooming or deforming upon receiving force from a driving implement.

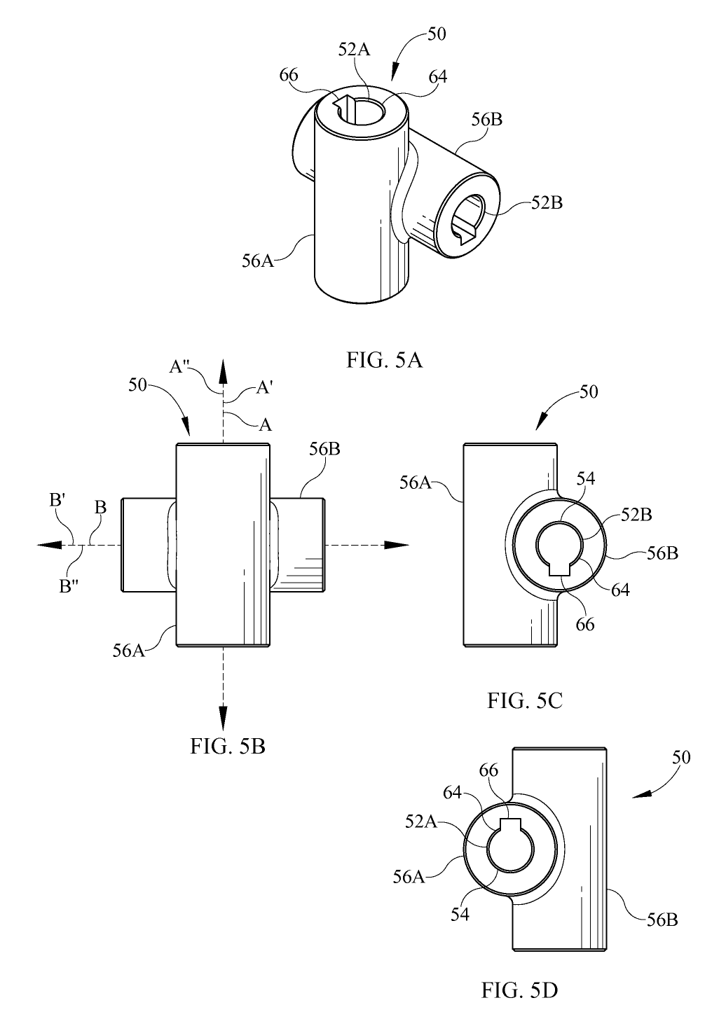

With reference to FIGS. 5A-5D, the alignment members 50 include a pair of channels 52A, 52B. Embodiments include those wherein the first channel 52A extends in a first direction A″ and the second channel extends in a second direction B″ that is substantially perpendicular to the first direction A. However, the directions A″, B″ of the channels 52A, 52B may be disposed relative to one another at any suitable angle. In some embodiments, each of the channels 52A, 52B extend lengthwise through each alignment member 50 such that the pair of channels 52A, 52B, includes a total of four channel openings 54. Alternatives include those wherein one of the channels 52A, 52B extends lengthwise through the alignment member 50 and one of the channels 52A, 52B partially extends through the alignment member 50 such that the pair of channels 52A, 52B includes a total of three channel openings 54. Additional alternatives include those wherein both of the channels 52A, 52B partially extend through the alignment member 50 such that the pair of channels 52A, 52B includes a total of two channel openings 54. The channels 52A, 52B are configured to correspondingly receive a respective one of the support poles 20 therein. A pole 20 may be slid into one of the channels 52A, 52B by inserting the first end 24 of the pole 20 into the channel 52A, 52B and sliding the alignment member 50 along the pole body 22 until the alignment member 50 reaches the desired location along the pole body 22.

The diameter of each channel 52A, 52B is slightly larger than the diameter of the pole body 22 in order to provide a snug friction fit engagement between the pole body 22 and the channel 52A, 52B so that the positioning of the alignment member 50 along the pole 20 is resistant to forces such as wind, passing animals and the weight of plant 82. This ensures that when the structure 12 is assembled, the configuration of grid arrangement 14 will remain substantially unchanged unless a user alters the configuration. In some embodiments, the diameter of each channel 52A, 52B is the same; however, it will be appreciated that the diameters of each channel 52A, 52B may be different in order to accommodate poles 20 having different diameters. If a user desires to change the position of the alignment member 50 on the pole 20, the friction fit between the pole body 22 and the channel 52A, 52B permits adjustment of the position of the alignment member 50 and the configuration of the grid arrangement 14 by sliding the alignment member 50 along the corresponding pole body 22. Similarly, if a user desires to disassemble the grid arrangement 14, each of the alignment members 50 may be slid off of the respective poles 20 thereby reducing the system 10 to the unassembled poles 20 and alignment members 50.

Embodiments include those wherein the alignment member 50 is comprised of molded plastic. However, any material that possesses a coefficient of friction relative to the material of the pole body that permits a snug friction fit engagement between the pole body 22 and the alignment member 50 such that the alignment member 50 is slidable along the pole body 22 may be used.

In some embodiments, the alignment members 50 include a pair of substantially cylindrical body portions 56A, 56B adjoined to one another. Alternatives include those wherein the body portions 56A, 56B are any other suitable shape including, for example, shapes with a cross-section that varies along their length such as, for example, a barrel and shapes that possess substantially the same cross-section along their length such as, for example, a prism derived from a polygon such as a parallelogram (e.g., a rectangular prism). The body portions 56A, 56B have longitudinal axes A, B, respectively, extending in a first direction A′ and a second direction B′, respectively. In some embodiments, the first direction A′ is substantially perpendicular to the second direction B′. However, the directions A′, B′ of the longitudinal axes A, B of the body portions 56A, 56B may be disposed relative to one another at any suitable angle. In the example embodiment illustrated, the direction A″ of the first channel 56A is substantially the same as the direction A′ of the longitudinal axis A of the first body portion 56A and the direction B″ of the second channel 56B is substantially the same as the direction B′ of the longitudinal axis B of the second body portion 56B. Alternatives include those wherein direction A′ is different from direction A″ and/or direction B′ is different from direction B″.

In the example embodiment illustrated, a portion of the body portions 56A, 56B are merged together such that the cylindrical profiles of the body portions 56A, 56B interfere with one another. Alternatives include those wherein the body portions 56A, 56B are adjoined to one another tangentially and those wherein the body portions 56A, 56B are adjoined to one another via an intermediate body portion disposed between them. However, it will be appreciated that where the body portions 56A, 56B are merged together, an overall reduction in size is accomplished relative to otherwise comparable portions adjoined in another manner.

In some embodiments, at least one of the channels 52A, 52B includes a first channel portion 64 and a second channel portion 66 abutting the first channel portion 64. The first channel portion 64 has a substantially circular cross-section correspondingly formed to receive and form a friction fit with a corresponding support pole 20. In the example embodiment illustrated, the second channel portion 66 has a substantially rectangular cross-section; however, any suitable cross-sectional shape may be employed as desired. In some embodiments, the second channel portion 66 is empty to reduce the friction between the pole body 22 and the alignment member 50 in order to ensure that a user is able to slide the pole 20 along the alignment member 50.

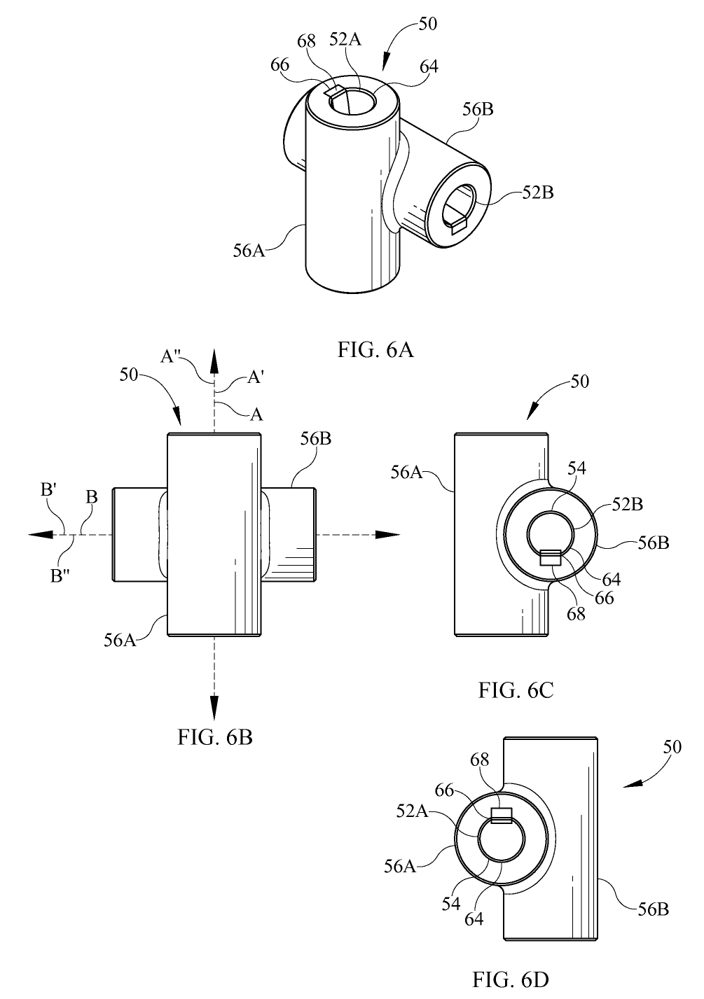

With reference to FIGS. 6A-6D, in some embodiments, a biasing member 68 is disposed in the second channel portion 66. The biasing member 68 applies a radial force to the pole body 22 in order to aid in holding the pole 20 in place relative to the alignment member 50. In the example embodiment shown, the biasing member 68 is a thin, flexible tab that extends the length of the channels 52A, 52B. In some embodiments, the biasing member 68 is biased toward the first channel portion 64 by a spring or other biasing means (not shown). Alternatives include those wherein the radial force provided by the biasing member 68 is derived from the positioning and flexibility of the biasing member 68. In some embodiments, the biasing member 68 is attached to the alignment member 50 by an adhesive or by fastening means such as, for example, a bolt or rivet. Alternatives include those wherein the biasing member 68 is received and held in place by engagement with an aperture such as a slit or slot on one or both ends of the channel 52A, 52B. In one embodiment, the biasing member 68 is composed of metal; however, any suitable material may be used.

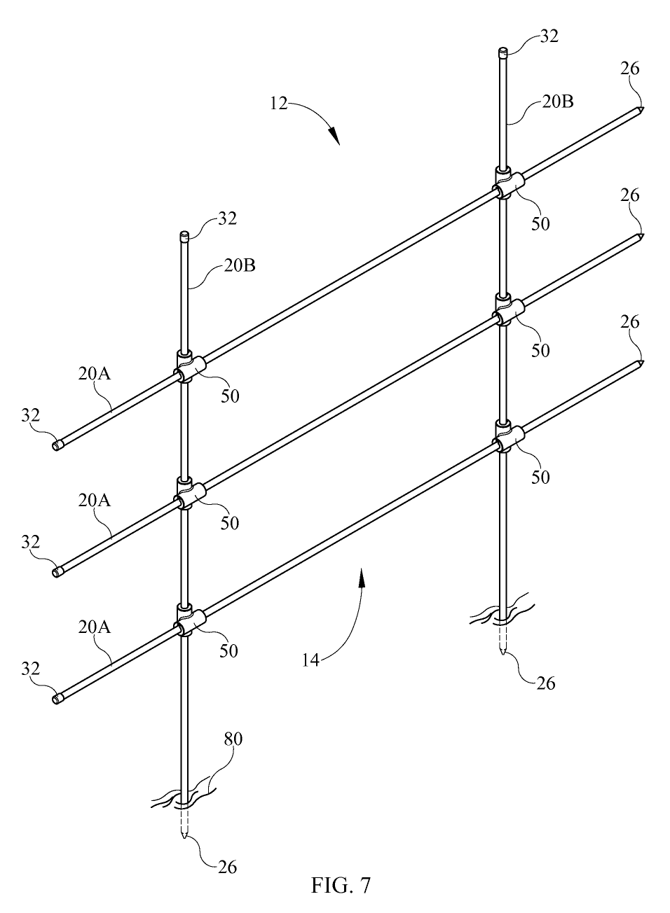

As shown in FIG. 7, the grid arrangement 14 according to a first example configuration includes at least one generally horizontal support pole 20A intersecting across at least one generally vertical support pole 20B. At least one of the generally vertical poles 20B is inserted into the support medium 80. The generally horizontal pole(s) 20A are supported by the generally vertical pole(s) 20B. The friction fit between the alignment members 50 and the poles 20 prevents the weight of the generally horizontal pole(s) 20A from causing them to slide down the generally vertical pole(s) 20B. Horizontal and vertical adjustment of the support poles 20 to compensate for plant 82 growth is permitted by sliding an alignment member 50 along a corresponding pole body 22.

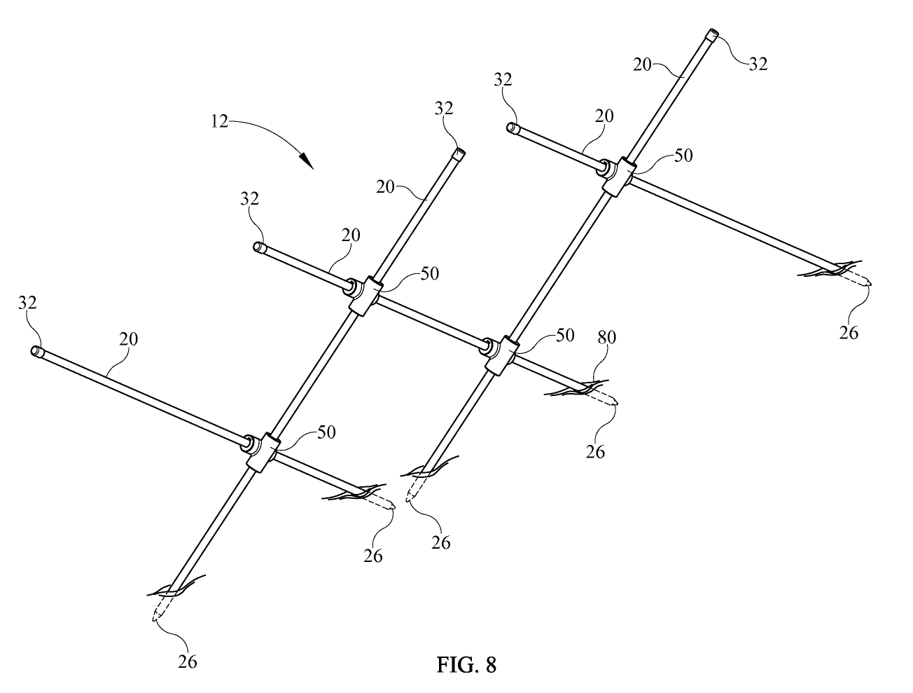

As shown in FIG. 8, the grid arrangement 14 according to a second example configuration includes at least a pair of support poles 20 in an inverted-V arrangement. Each of the poles 20 is inserted diagonally into the support medium 80. In some embodiments, the grid arrangement 14 includes discrete pairs of joined, intersecting poles 20. The pairs of joined poles 20 may be disposed adjacent to one another in order to increase the overall size of the arrangement 14. Alternative embodiments include those wherein at least one of the poles 20 is joined with more than one pole 20 as shown in FIG. 8 such that the grid arrangement 14 is made up of at least three diagonally disposed poles 20 interconnected in a series.

According to one embodiment, the garden support structure 12 is provided by joining at least two poles 20 in the grid arrangement 14 using at least one alignment member 50. A first pole 20 is inserted into the first channel 52A of the alignment member 50. The alignment member 50 is slid to a predetermined position along the first support pole 20. A second support pole 20 is then inserted into the second channel 52B of the alignment member 50. The alignment member 50 is slid to a predetermined position along the second support pole 20. Either prior to or after the poles 20 are joined, the tapered portion 26 of at least one of the poles 20 is driven into the support medium 80 for supporting the structure 12. The structure 12 may be placed next to an existing plant 82 or a plant 82 may be planted next to the structure 12 after the structure 12 has been inserted into the support medium 80. As desired, the plant 82 may be attached to the structure 12, such as by tying the plant 82 to the structure 12, to ensure that sufficient support is provided.

As desired, the dimensions of the grid arrangement 14 may be adjusted by sliding the alignment member 50 along one of the pole bodies 22. For example, where the grid arrangement 14 is comprised of at least one generally horizontal support pole 20A and at least one generally vertical support pole 20B, at the beginning of the growing season it may be desirable to have relatively narrow vertical spacing between the bottom generally horizontal support pole 20A and the support medium 80 and between each successive generally horizontal support pole 20A. As an adjacent plant 82 grows during the season, it may be desirable to raise the generally horizontal support pole(s) 20A. The vertical position of the generally horizontal support pole(s) 20A may be adjusted by sliding one or more of the alignment members 50 along the generally vertical support pole(s) 20B. For instance, by sliding an alignment member 50 upward along a corresponding generally vertical support pole 20B, a corresponding generally horizontal support pole 20A attached thereto is raised. Similarly, the horizontal position of the generally vertical support pole(s) 20B may be adjusted by sliding one or more of the alignment members 50 along the generally horizontal support pole(s) 20A. In order to disassemble the structure 12, the poles 20 are removed from the support medium 80. Each of the poles 20 are slid out of the alignment members 50 until the structure 12 is broken down to the various poles 20 and alignment members 50.

Accordingly, it will be appreciated that the garden support system 10 provides a customizable and adjustable support structure 12. This allows effective use of the structure 12 with a number of different types of plants including, for example, cucumber and tomato to plants, as well as plants that vary greatly in height as they grow. A user can select the number of poles 20 and the arrangement of the poles thereby providing the user with the ability to control the amount of space consumed by the structure 12. This allows the user to either conserve space by using relatively few poles 20 or to construct a relatively large structure 12 with many poles 20 depending on his or her personal needs. The elongated pole bodies 22 also allow the user to insert the poles 20 deep into the support medium 80 thus ensuring stability of the structure 12. The impact cap 32 and tapered portion 26 allow for ease of insertion. Further, the structure 12 can be disassembled without breaking or bending the poles 20 so that the poles 20 can be conveniently stored and reused. When the structure 12 is disassembled, the poles 20 and alignment members 50 can be bundled and stored in a relatively small space. Alternatively, the structure 12 may be removed from the support medium 80 without disassembling it. Because the structure 12 is relatively flat, it can easily be hung on a wall, such as in a garage or shed, without taking up a large amount of space.

The foregoing description of multiple embodiments has been presented for purposes of illustration. It is not intended to be exhaustive or to limit the application to the precise steps and/or forms disclosed, and many modifications and variations are possible in light of the above teaching. It is intended that the scope of the application be defined by the claims appended hereto.

What is claimed is:

1. A garden support system, comprising:
a plurality of support poles having a generally elongated pole body, at least one of the support poles having a first end that includes a tapered portion for insertion into a support medium; and
a plurality of alignment members for joining the support poles in a grid arrangement for supporting at least one plant, the alignment members each having a pair of channels each for receiving a corresponding support pole therein;
wherein when the alignment members and support poles are joined, the alignment members hold the support poles in place by a friction fit between the respective pole bodies and channels and permit adjustment of the grid arrangement by sliding an alignment member along a corresponding pole body.

2. The garden support system of claim 1, wherein at least one of the support poles includes an impact cap with a flat nail-head surface attached to a second end of the support pole opposite the first end for receiving a driving force to drive the support pole into the support medium.

3. The garden support system of claim 2, wherein the impact cap has a generally cylindrical body having an access opening correspondingly formed to receive the second end of the support pole, the impact cap being fitted over the pole body.

4. The garden support system of claim 3, wherein the impact cap includes a substantially planar interior surface opposing the access opening and the second end of the support pole includes a substantially planar upper surface abutting the substantially planar interior surface of the impact cap.

5. The garden support system of claim 1, wherein at least one of the pair of channels of the alignment members includes a first channel portion having a substantially circular cross-section correspondingly formed to receive and form a friction fit with a corresponding support pole and a second channel portion abutting the first channel portion.

6. The garden support system of claim 5, wherein the second channel portion has a substantially rectangular cross-section.

7. The garden support system of claim 5, further comprising a biasing member disposed in the second channel portion for applying a radial force to the pole body to hold the support pole in place relative to the alignment member.

8. The garden support system of claim 1, wherein a first of the pair of channels extends in a first direction and a second of the pair of channels extends in a second direction that is substantially perpendicular to the first direction.

9. The garden support system of claim 1, wherein the pair of channels each extend lengthwise through each alignment member.

10. The garden support system of claim 1, wherein the grid arrangement includes at least one generally horizontal support pole intersecting across at least one generally vertical support pole and horizontal and vertical adjustment of the support poles to compensate for plant growth is permitted by sliding an alignment member along a corresponding pole body.

11. The garden support system of claim 1, wherein the grid arrangement includes a pair of diagonal support poles joined with and intersecting across one another.

12. A garden support system, comprising:
a plurality of support poles having a generally elongated and substantially straight pole body, at least one of the support poles having a first end that includes a tapered portion for insertion into a support medium; and
a plurality of alignment members for joining the support poles in an arrangement for supporting at least one plant, the alignment members each having a pair of substantially cylindrical body portions adjoined to one another, each of the substantially cylindrical body portions having a channel for receiving a corresponding support pole therein and forming a friction fit therewith;
wherein the friction fit permits assembly and disassembly of the arrangement by sliding each alignment member along at least one corresponding pole body.

13. The garden support system of claim 12, wherein a first of the pair of substantially cylindrical body portions has a first longitudinal axis that extends in a first direction and a second of the pair of substantially cylindrical body portions has a second longitudinal axis that extends in a second direction that is substantially perpendicular to the first direction.

14. The garden support system of claim 12, wherein at least one of the support poles includes an impact cap with a flat nail-head surface attached to a second end of the support pole opposite the first end for receiving a driving force to drive the support pole into the support medium.

15. The garden support system of claim 14, wherein the impact cap has a generally cylindrical body having an access opening correspondingly formed to receive the second end of the support pole, the impact cap being fitted over the pole body.

16. The garden support system of claim 15, wherein the impact cap includes a substantially planar interior surface opposing the access opening and the second end of the support pole includes a substantially planar upper surface abutting the substantially planar interior surface of the impact cap.

17. The garden support system of claim 12, wherein at least a portion of the substantially cylindrical body portions are merged together such that the substantially cylindrical profiles of the substantially cylindrical body portions interfere with one another.

18. The garden support system of claim 12, wherein at least one of the pair of channels of the alignment members includes a first channel portion having a substantially circular cross-section correspondingly formed to receive and form a friction fit with a corresponding support pole and a second channel portion abutting the first channel portion.

19. The garden support system of claim 18, wherein the second channel portion has a substantially rectangular cross-section.

20. The garden support system of claim 18, further comprising a biasing member disposed in the second channel portion for applying a radial force to the pole body to hold the support pole in place relative to the alignment member.

21. The garden support system of claim 12, wherein the pair of channels each extend lengthwise through each substantially cylindrical body portion.

22. A method for providing a garden support structure, comprising:
joining a plurality of support poles having a generally elongated pole body in a grid arrangement using at least one alignment member having a pair of channels each for receiving a corresponding support pole therein by:
inserting a first support pole into a first channel of the alignment member;
sliding the alignment member to a predetermined position along the first support pole;
inserting a second support pole into a second channel of the alignment member; and
sliding the alignment member to a predetermined position along the second support pole.

23. The method of claim 22, further comprising inserting a tapered end portion of at least one of the support poles into a support medium for supporting the garden support structure.

24. The method of claim 22, further comprising adjusting the dimensions of the grid arrangement by sliding the alignment member along a corresponding pole body.

25. The method of claim 24, wherein adjusting the dimensions of the grid arrangement is performed in response to the growth of an adjacent plant.

26. The method of claim 24, wherein the grid arrangement includes at least one generally horizontal support pole and at least one generally vertical support pole and adjusting the dimensions of the grid arrangement includes at least one of adjusting the vertical position of the at least one generally horizontal support pole by sliding the alignment member vertically along the at least one generally vertical support pole and adjusting the horizontal position of the at least one generally vertical support pole by sliding the alignment member horizontally along the at least one generally horizontal support pole.
